(19) United States
(12) Patent Application Publication
(10) Pub. No.: US 2026/0099289 A1
(43) Pub. Date: Apr. 9, 2026

(54) INTENT-BASED CONTENT

(71) Applicant: Apple Inc., Cupertino, CA (US)

(72) Inventors: Keith W. RAUENBUEHLER, San Francisco, CA (US); Christopher J. LEE, Los Altos, CA (US); Shivesh MAKHARIA, Los Gatos, CA (US); Vincenzo O. GIULIANI, Thousand Oaks, CA (US)

(21) Appl. No.: 19/349,160

(22) Filed: Oct. 3, 2025

Related U.S. Application Data
(60) Provisional application No. 63/703,712, filed on Oct. 4, 2024.

(51) Int. Cl. G06F 3/14

(52) U.S. Cl. CPC G06F 3/14

(57) ABSTRACT

The present disclosure generally relates to displaying different content based on user intent for interacting with accessories.

### CROSS-REFERENCE TO RELATED APPLICATIONS

This application claims the benefit of U.S. Provisional patent application Ser. No. 63/703,712, entitled “INTENT-BASED CONTENT,” filed Oct. 4, 2024, which is hereby incorporated by reference herein in its entirety.

### BACKGROUND

Electronic devices are becoming increasingly interconnected. For example, electronic devices such as smartphones are often connected to accessory devices in homes and offices.

Interacting with such accessory devices has become more complex as the number of connected accessory devices and their functionalities have increased. Accordingly, there is a need to improve techniques for adapting content based on user intent for interacting with these accessory devices.

### SUMMARY

Current techniques for displaying different content based on user intent are generally ineffective and/or inefficient. For example, some techniques require users to navigate through different user interfaces, menus and/or applications on their device to access controls and statuses of accessory devices in their homes. This disclosure provides more effective and/or efficient techniques for intent-aware content for electronic device interactions with accessory devices. It should be recognized that other types of electronic devices and accessory devices can be used with techniques described herein. For example, a smartwatch can connect with a speaker using techniques described herein. In addition, techniques optionally complement or replace other techniques for displaying different content based on user intent.

Some techniques are described herein for providing different content corresponding to an accessory device depending on different sets of one or more criteria being satisfied. For example, certain content can be provided when an accessory device is within a first distance while other content can be provided when the accessory device is within a second distance different from the first distance.

In some embodiments, a method that is performed at a computer system that is in communication with one or more display generation components is described. In some embodiments, the method comprises: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

In some embodiments, a non-transitory computer-readable storage medium storing one or more programs configured to be executed by one or more processors of a computer system that is in communication with one or more display generation components is described. In some embodiments, the one or more programs includes instructions for: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

In some embodiments, a transitory computer-readable storage medium storing one or more programs configured to be executed by one or more processors of a computer system that is in communication with one or more display generation components is described. In some embodiments, the one or more programs includes instructions for: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

In some embodiments, a computer system configured to communicate with one or more display generation components is described. In some embodiments, the computer system comprises one or more processors and memory storing one or more programs configured to be executed by the one or more processors. In some embodiments, the one or more programs includes instructions for: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

In some embodiments, a computer system configured to communicate with one or more display generation components is described. In some embodiments, the computer system comprises means for performing each of the following steps: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

In some embodiments, a computer program product is described. In some embodiments, the computer program product comprises one or more programs configured to be executed by one or more processors of a computer system that is in communication with one or more display generation components. In some embodiments, the one or more programs include instructions for: detecting an accessory device in proximity to the computer system, wherein the accessory device is separate from the computer system; and in response to detecting the accessory device in proximity to the computer system: in accordance with a determination that a first set of one or more criteria is satisfied, displaying, via the one or more display generation components, a first set of content corresponding to the accessory device; and in accordance with a determination that a second set of one or more criteria is satisfied, displaying, via the one or more display generation components, a second set of content corresponding to the accessory device, wherein the second set of content is different from the first set of content.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIGS. 3A-3J illustrate exemplary user interfaces for displaying different content based on user intent in accordance with some embodiments.

FIG. 4 is a flow diagram illustrating a process for displaying different content based on user intent in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting.

As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

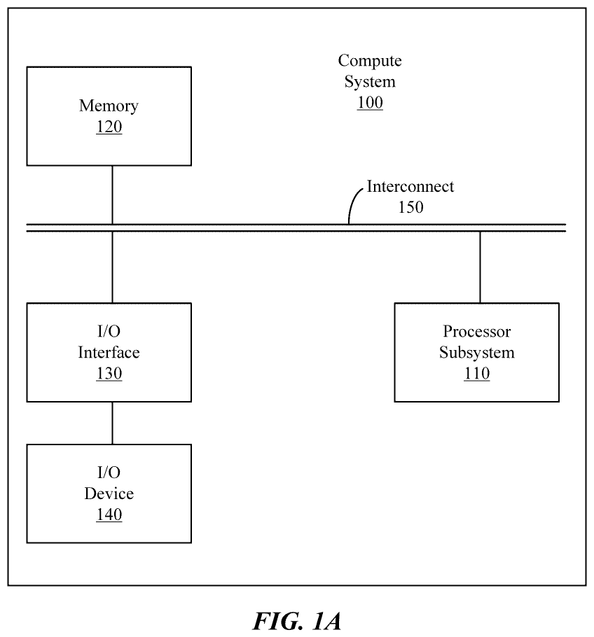

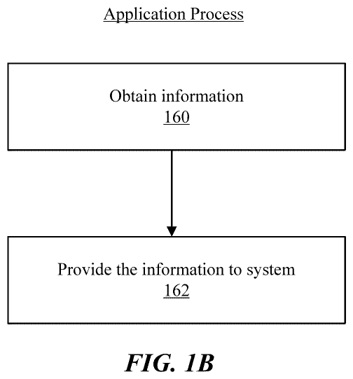

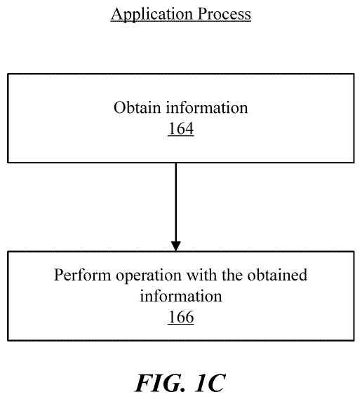

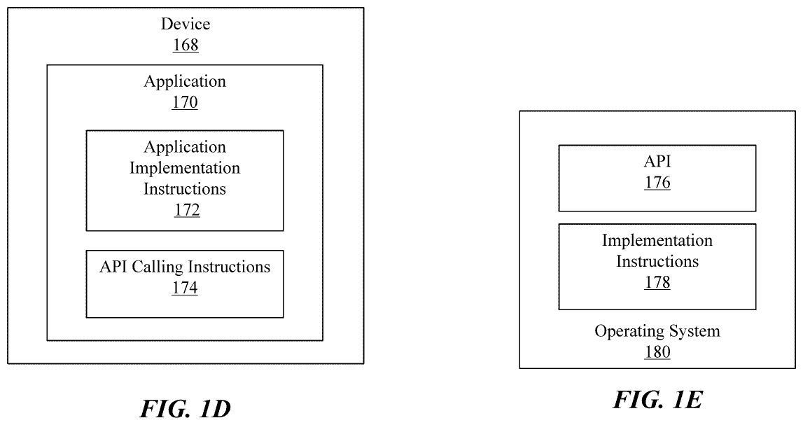

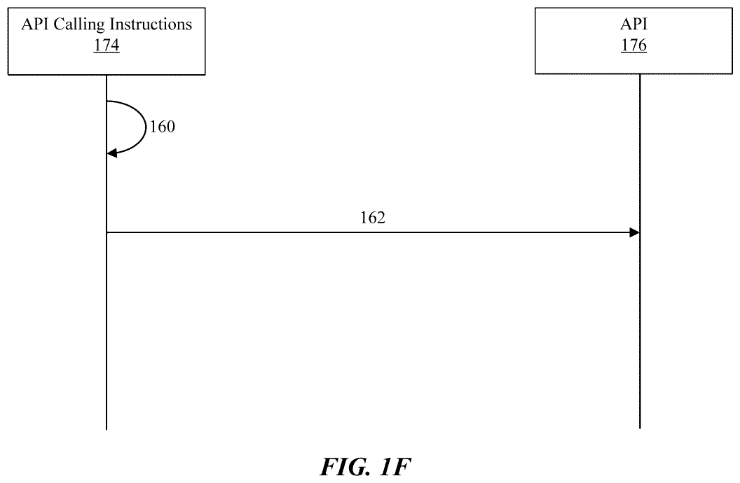

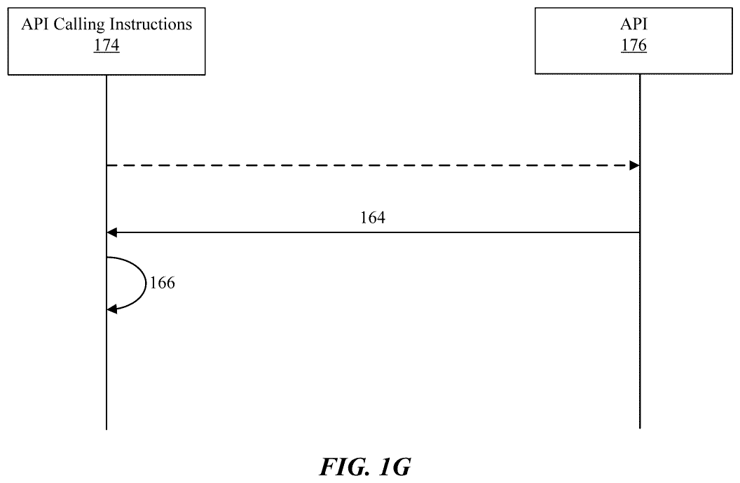

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

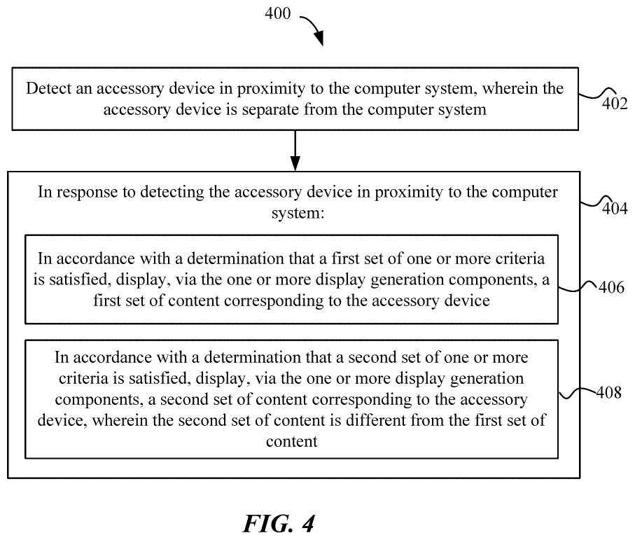

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with process 400 (FIG. 4) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

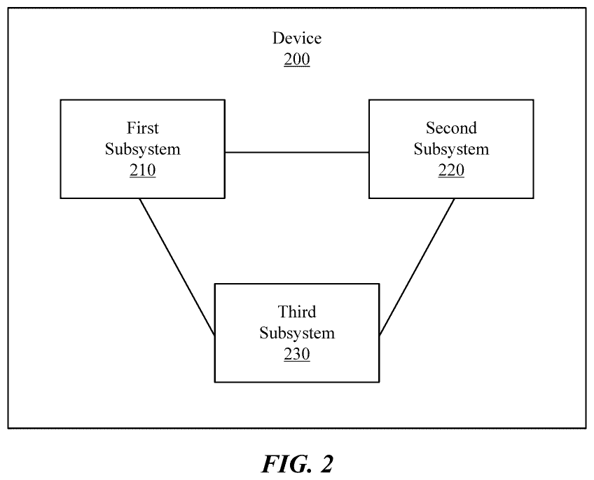

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100).

Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for displaying different content based on user intent. Such techniques are described in the context of an electronic device connecting with and/or controlling accessories. It should be recognized that other types of electronic devices and accessories can be used with techniques described herein. For example, a smartphone can connect with a door lock using techniques described herein. In addition, techniques optionally complement or replace other techniques for displaying different content based on user intent.

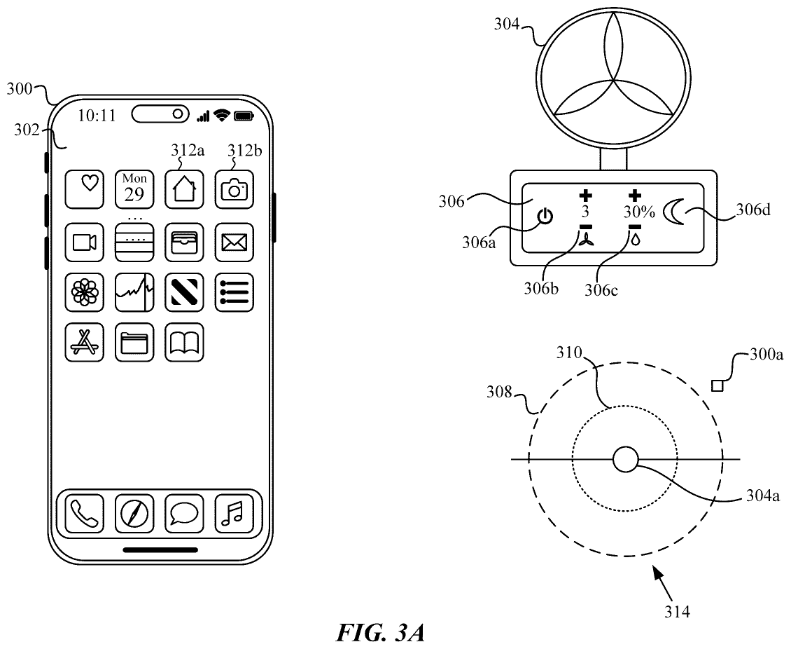

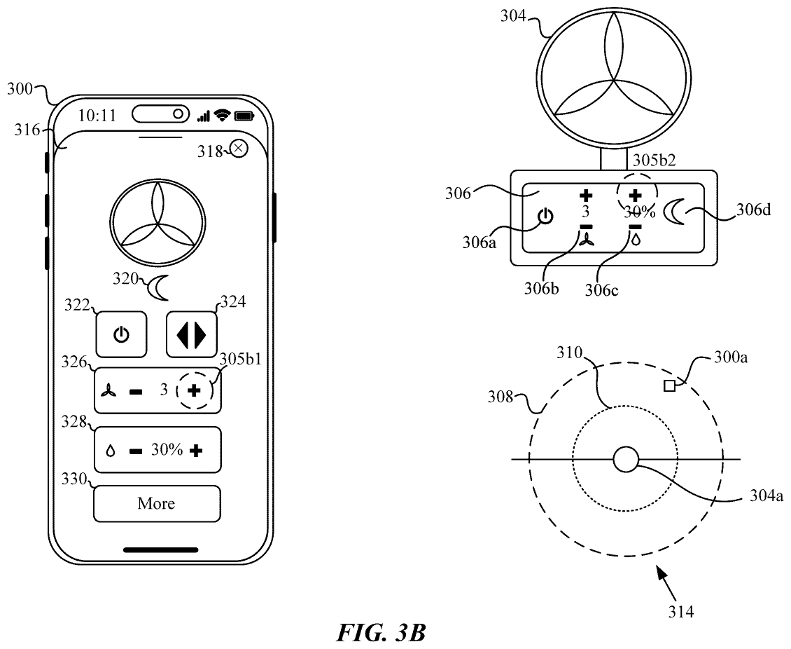

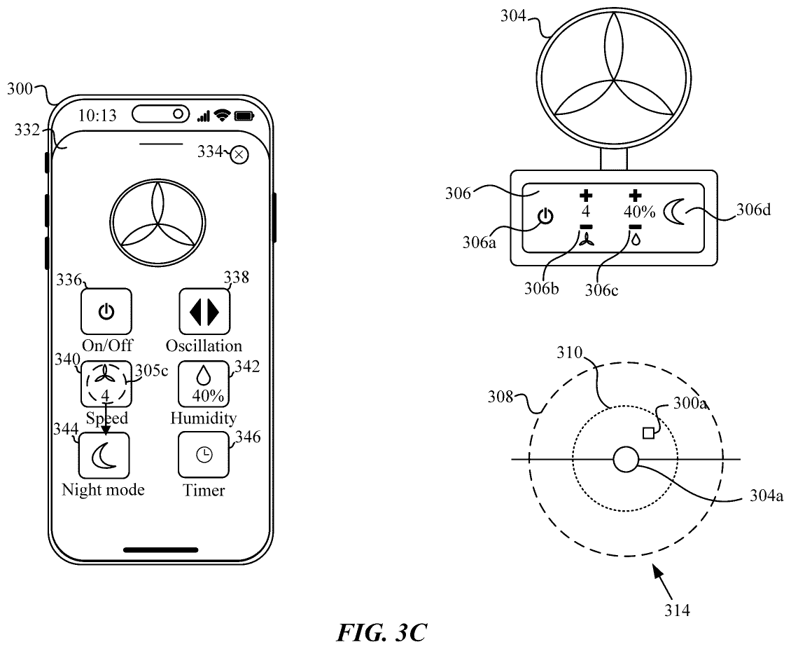

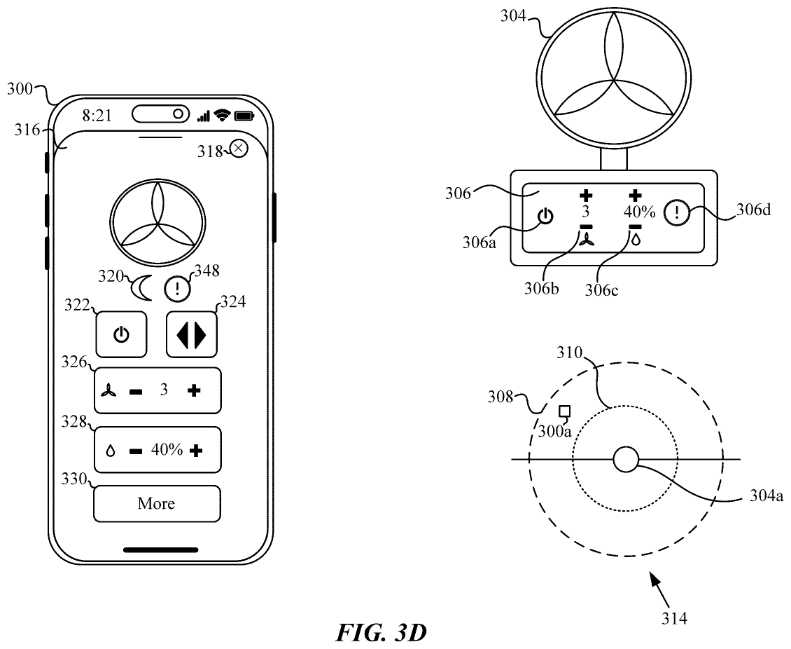

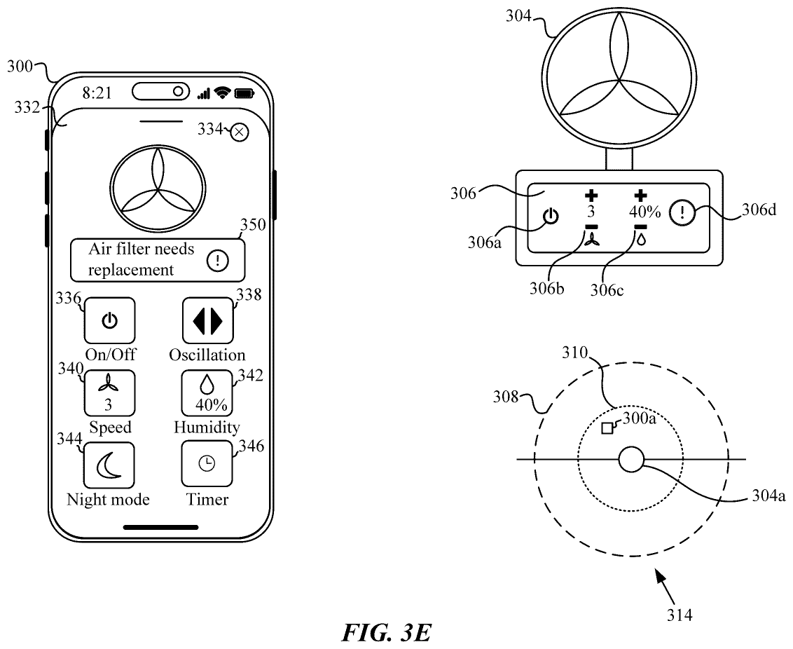

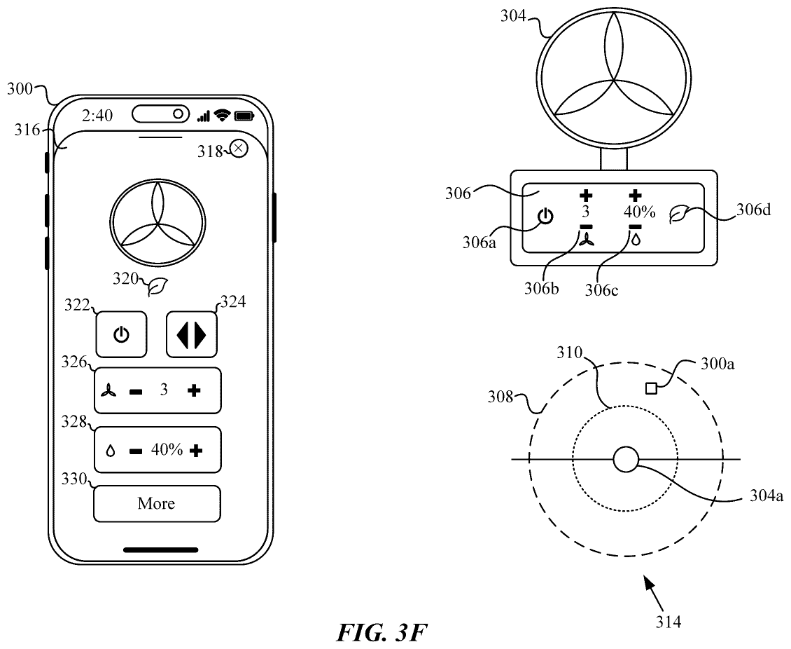

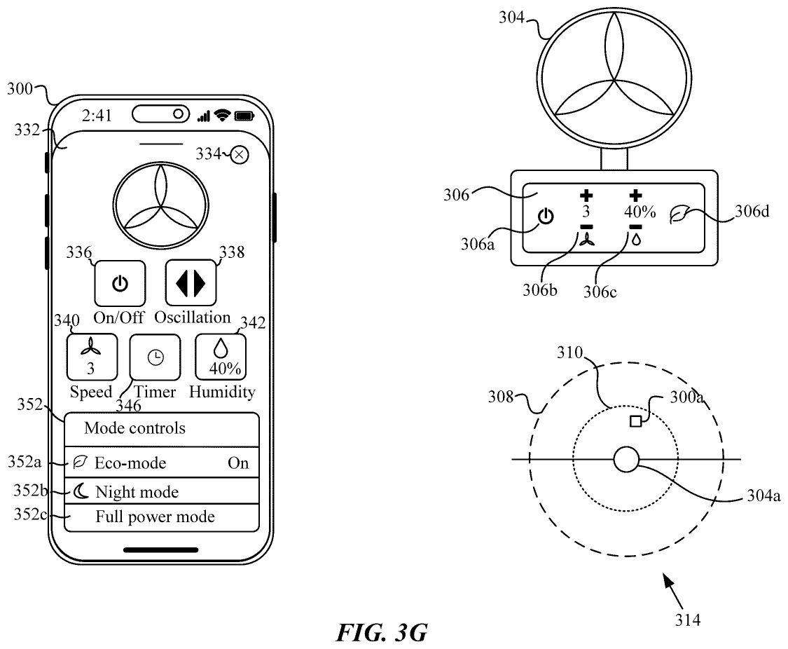

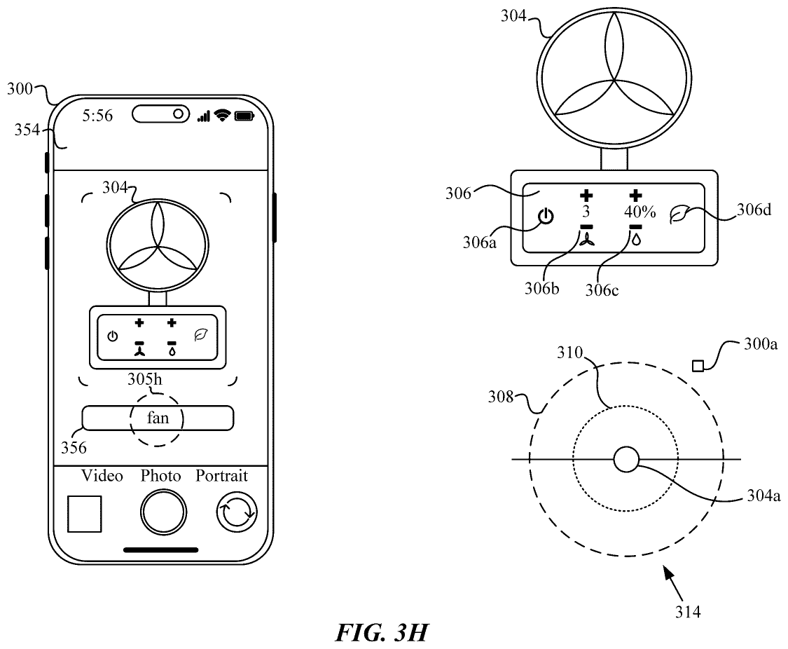

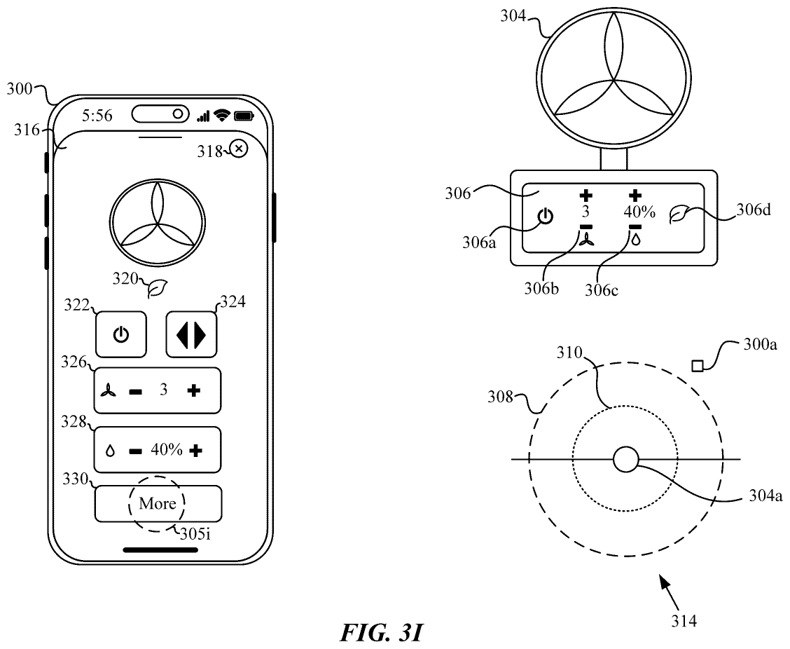

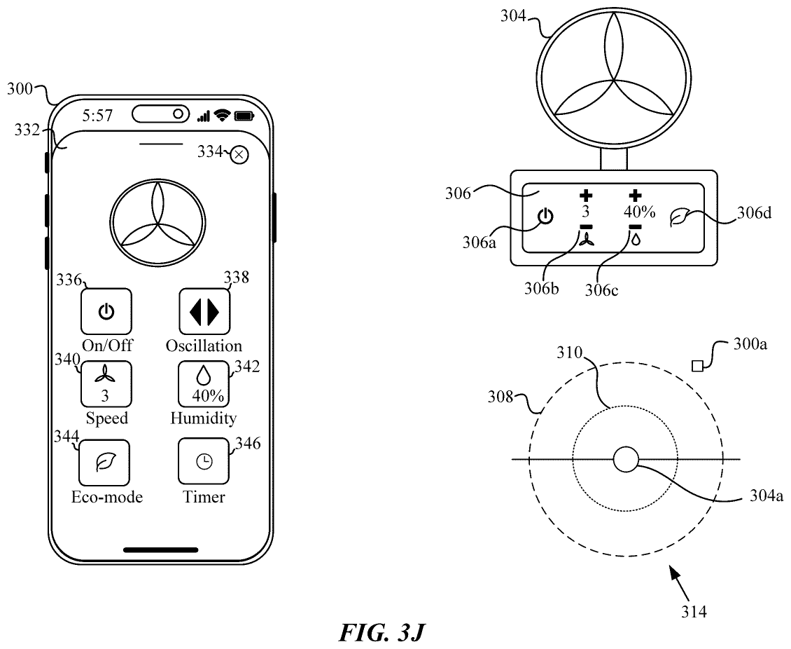

FIGS. 3A-3J illustrate exemplary user interfaces for interacting with accessory devices based on user intent in accordance with some embodiments. The user interfaces in these figures are used to illustrate the processes described below, including the process in FIG. 4.

FIGS. 3A-3J illustrate computer system 300 as a smart phone and fan 304 as an accessory device in a security domain within computer system 300. It should be recognized that computer system 300 can be other types of devices, such as a smart watch, a tablet, a laptop, a desktop, a communal device, an accessory (sometimes referred to herein as an accessory device), a personal gaming system, a fitness tracking device, and/or a head-mounted display (HMD) device. In some embodiments, computer system 300 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 300 includes and/or is in communication with one or more output devices (e.g., a display screen, a projector, a touch-sensitive display, and/or a speaker). In some embodiments, computer system 300 includes one or more components and/or features described above in relation to compute system 100 and/or device 200. It should be recognized that fan 304 can be other types of devices, such as a smart watch, a tablet, a laptop, a desktop, a communal device, a personal gaming system, a fitness tracking device, a head-mounted display (HMD) device, a light, thermostat, speaker, camera, and/or door lock. In some embodiments, fan 304 includes and/or is in communication with one or more input devices (e.g., a sensor, a camera, a lidar detector, a motion sensor, an infrared sensor, a touch-sensitive surface, a physical input mechanism, and/or a microphone). In some embodiments, fan 304 includes and/or is in communication with one or more output devices (e.g., a display screen, a projector, a touch-sensitive display, and/or a speaker). In some embodiments, fan 304 includes one or more components and/or features described above in relation to compute system 100 and/or device 200.

FIGS. 3A-3J are split between a left side, a bottom side, and a top side. In the examples illustrated in FIGS. 3A-3J, the bottom side illustrates a top-down schematic view of physical environment 314 that includes computer system representation 300a (e.g., representing computer system 300) and fan representation 304a (e.g., representing fan 304). In some embodiments, the relative positioning of computer system representation 300a and fan representation 304a is indicative of relative physical positioning in a physical environment. The top-down schematic view includes larger proximity radius 308 (represented by a first type of dotted lines around fan representation 304a) and smaller proximity radius 310 (represented by a second type of dotted lines around fan representation 304a). The left side of FIGS. 3A-3J illustrate output of computer system 300. The top side of FIGS. 3A-3J illustrate output of fan 304. While FIGS. 3A-3J illustrate computer system 300 and fan 304 outputting particular content, it should be recognized that such content is merely for explanatory purposes and that such content can be in different forms, at different locations, at different sizes, include different content, and/or that more, fewer, and/or different content can be output in accordance with techniques described herein. In some embodiments, fan 304 does not output any content.

While the examples in FIGS. 3A-3J include computer system 300 and fan 304 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 300 and/or fan 304 are passive inputs that are not purposefully directed at computer system 300 and/or fan 304 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

In the examples described below with respect to FIGS. 3A-3J, computer system 300 displays user interfaces (e.g., 316 and/or 332) of a home application and user interfaces (e.g., 302 and/or 354) of an operating system. In some embodiments, the home application is an application that allows a user to control, communicate with, and/or check a status of one or more accessories. In some embodiments, the operating system is software (sometimes referred to as an application) that manages hardware and/or software resources of computer system 300. In such embodiments, system processes, such as services and/or daemons, can perform operations on behalf of the operating system. It should be recognized that user interfaces described herein for the home application can be user interfaces of another type of application, including a user interface of the home application being a user interface of the operating system that includes data and/or content from the home application.

At FIGS. 3A-3J, computer system 300 implements a process for displaying different user interfaces and/or different user interface elements depending on a determination of an intent of a user to interact with fan 304. In some embodiments, the determination is based on, but not limited to, a proximity of computer system 300 to fan 304 and/or communication via one or more short-range communication technologies, such as Near Field Communication (NFC), Bluetooth Low Energy (BLE), and/or Ultra-Wideband (UWB). For example, computer system 300 can detect presence of an NFC tag of fan 304 to determine the intent of a user to interact with fan 304. For another example, computer system 300 can measure a Received Signal Strength Indicator (RSSI) from a BLE beacon of fan 304 to estimate a proximity of computer system 300 to the accessory device, with stronger signals indicating closer proximity, to determine the intent of a user to interact with fan 304.

In some embodiments, an intent for a user to interact with an accessory device is determined at a granularity of three different intents, such as no intent, general intent, and specific intent. In such embodiments, general intent can be that a user wants to generally control an accessory device but does not need more specific information and/or specific controls. In some embodiments, an intent of a user to interact with fan 304 is no intent when computer system representation 300a is outside of larger proximity radius 308. In some embodiments, an intent of a user to interact with fan 304 is a general intent when computer system representation 300a is inside of larger proximity radius 308 but outside of smaller proximity radius 310. In some embodiments, an intent of a user to interact with fan 304 is a specific intent when computer system representation 300a is inside of smaller proximity radius 310. It should be recognized that such intents can be defined differently as described further below with respect to FIG. 6H.

As illustrated in FIG. 3A, fan 304 displays user interface 306 with a set of controls and/or indicators, including power control 306a, fan speed controls 306b, humidifier controls 306c, and indicator 306d. Fan speed controls 306b includes an indicator for current speed (e.g., 3), humidifier controls 306c includes an indicator for current humidity (e.g., 30%), and indicator 306d is represented as a moon icon to indicate a night mode as further described below. It should be recognized that user interface 306 can include more, fewer, and/or different content than illustrated in FIG. 3A.

Also illustrated in FIG. 3A, computer system 300 displays user interface 302 as a home screen with an application grid including application icons 312. As will be discussed below, each icon in application icons 312 can correspond to a different application, such as home icon 312a corresponding to the home application and camera icon 312b corresponding to a camera application. It should be recognized that user interface 302 can include more, fewer, and/or different content than illustrated in FIG. 3A. It should also be recognized that user interface 302 can be other types of user interfaces, such as a lock screen or a user interface of another application. In some embodiments, user interface 302 is displayed based on a determination that a user intent for interacting with fan 304 is not present (e.g., no intent), such as because computer system representation 300a is outside of larger proximity radius 308 relative to fan 304a (e.g., based on a lack of proximity of computer system 300 to fan 304).

As illustrated in FIG. 3B, computer system representation 300a enters larger proximity radius 308, such as by a user holding computer system 300 while moving closer to fan 304. In some embodiments, in response to computer system representation 300a entering larger proximity radius 308, computer system 300 detects a general intent for a user to interact with fan 304. And, in some embodiments, as illustrated in FIG. 3B, computer system changes display to user interface 316 in response to detecting the general intent for a user to interact with fan 304.

In some embodiments, user interface 316 includes a simplified set of controls for fan 304, though more controls than user interface 306. For example, user interface 316 can include an indication of a current mode of fan 304 (such as mode indicator 320 representing an active night mode) and a set of quick controls (such as power control 322, oscillation control 324, speed controls 326, and humidifier controls 328) for controlling fan 304. Additionally, in some embodiments, user interface 316 includes more button 330 (labeled “More”) that, when selected, provides access to typically less frequently used and/or more advanced controls of fan 304. It should be recognized that controls displayed in user interface 316 can vary based on a type of accessory device. For example, user interface 316 can display other controls including locking and/or unlocking controls if an accessory device is a door lock. In some embodiments, user interface 316 is designed for quick interactions that allow a user of computer system 300 to make adjustments to fan 304 without a need for navigating through multiple menus and/or user interfaces. In some embodiments, user interface 316 is partially overlaid on top of previously displayed content (e.g., user interface 302). It should be recognized that user interface 316 can include more or less of a displayed area of computer system 300, including by allowing more or less of the previously displayed content to be visible under user interface 316. In other embodiments, user interface 316 can occupy a full display screen of computer system 300, allowing none of the previously displayed content to be visible under user interface 316. In some embodiments, in response to detecting an input such as a swipe down input at the top of the user interface 316 and/or a tap input on close button 318, computer system 300 dismisses and/or ceases display of user interface 316.

At FIG. 3B, computer system 300 detects (1) selection input 305b1 on speed controls 326 for increasing a speed of fan blades of fan 304 and (2) selection input 305b2 on humidity controls 306c for increasing a targeted humidity in physical environment 314. It should be recognized that input 305b1 and input 305b2 are examples of tap inputs and can be other types of inputs such as a mouse click, a verbal input, and/or an air gesture directed at speed controls 326 and/or humidity controls 306c.

As illustrated in FIG. 3C, in response to selection input 305b1, the speed of fan blades of fan 304 increases from 3 to 4, as illustrated by “4” in speed controls 340 and “4” in speed controls 306b. As illustrated in FIG. 3C, in response to selection input 305b2, the target humidity of fan 304 increases from 30% to 40%, as illustrated by “40%” in humidity controls 342 and “40%” in humidity controls 306c.

Also as illustrated in FIG. 3C, computer system representation 300a enters smaller proximity radius 310, such as by a user holding computer system 300 while moving even closer to fan 304. In some embodiments, in response to computer system representation 300a entering smaller proximity radius 310, computer system 300 detects a specific intent for a user to interact with fan 304. And, in some embodiments, as illustrated in FIG. 3C, computer system 300 changes display to user interface 332 in response to detecting the specific intent for a user to interact with fan 304.

In some embodiments, user interface 332 includes a larger set of controls for fan 304 than that of user interface 316 (and/or user interface 306). In some embodiments, user interface 332 includes similar controls as user interface 316, such as power control 336 labeled as “On/Off”, oscillation control 338 labeled as “Oscillation”, speed control 340 labeled as “Speed”, and humidifier control 342 labeled as “Humidity”. In some embodiments, these controls allow different input mechanisms (e.g., a swipe input instead of a tap input as described below), more advanced options (e.g., setting a timer as described below), and/or different granularity of control (e.g., a distance of an input rather than that an input occurred as described below). Additionally, user interface 332 includes more advanced and/or less frequently used controls of fan 304. In some embodiments, user interface 332 replaces mode indicator 320 of user interface 316 with mode control 344 for changing a mode of fan 304.

Additionally, in some embodiments, user interface 332 displays additional controls such as timer control 346 labelled as “Timer” for setting a timer on an activity of fan 304. It should be recognized that controls displayed in user interface 332 can vary based on a type of accessory device. For example, user interface 332 can display other controls including lock activity history and/or security settings if an accessory device is a door lock. In some embodiments, user interface 332 is designed for more detailed interactions that allow a user of computer system 300 to access and/or adjust a wider range of features and/or functionalities of fan 304.

As illustrated in FIG. 3C, user interface 332 is partially overlaid on top of previously displayed content (e.g., user interface 302). It should be recognized that user interface 322 can include more or less of a displayed area of computer system 300, including by allowing more or less of the previously displayed content to be visible under user interface 332. In other embodiments, user interface 332 can occupy a full display screen of computer system 300, allowing none of the previously displayed content to be visible under user interface 332. In some embodiments, in response to detecting an input such as a swipe down input at the top of user interface 322 and/or a tap input on close button 334. computer system 300 dismisses and/or ceases display of user interface 332.

At FIG. 3C, computer system 300 detects movement input 305c on speed controls 340 for decreasing a speed of fan blades of fan 304. It should be recognized that movement input 305c is an example of a swipe down input and can be other types of inputs such as a mouse click, a verbal input, and/or an air gesture directed at speed controls 340 for decreasing a speed of fan blades of fan 304.

As illustrated in FIG. 3D, in response to movement input 305c, the speed of fan blades of fan 304 decreases from 4 to 3, as illustrated by “3” in speed controls 326 and “3” in speed controls 306b of fan 304. Also as illustrated in FIG. 3D, computer system representation 300a moves out of smaller proximity radius 310 and into larger proximity radius 308, such as by a user holding computer system 300 while moving farther away from fan 304. In some embodiments, in response to computer system representation 300a entering larger proximity radius 308, computer system 300 detects a general intent for a user to interact with fan 304. And, in some embodiments, as illustrated in FIG. 3D, computer system 300 changes display to user interface 316 in response to detecting the general intent for a user to interact with fan 304. In some embodiments, user interface 316 includes a simplified set of controls for fan 304, as described above with respect to FIG. 3B.

Also as illustrated in FIG. 3D, indicator 306d of fan 304 includes a warning icon to indicate a missing configuration of fan 304. In some embodiments, user interface 316 reflects the missing configuration of fan 304 by including warning indicator 348 adjacent to mode indicator 320 to allow easy access to such warning information of fan 304 on computer system 300. It should be recognized that, in some embodiments, presence of the missing configuration can cause a determination to be made that a user has a specific intent to interact with fan 304 when computer system 300 has not previously displayed warning indicator 438 and/or warning indicator 438 has been displayed for less than a predefined period of time (e.g., 1 day to 1 week). In such embodiments, computer system 600 can display user interface 332 (e.g., as described below with respect to FIG. 3E) instead of user interface 316 (e.g., as described above with respect to FIG. 3D) even when computer system representation 300a is outside of smaller proximity radius 310 but inside larger proximity radius 308.

As illustrated in FIG. 3E, computer system representation 300a moves into smaller proximity radius 310, such as by a user holding computer system 300 while moving closer to fan 304. In some embodiments, in response to computer system representation 300a entering smaller proximity radius 310, computer system 300 detects a specific intent for a user to interact with fan 304. And, in some embodiments, as illustrated in FIG. 3E, in response to detecting the specific intent for a user to interact with fan 304, computer system 300 changes display to user interface 332. In some embodiments, user interface 332 includes a larger set of controls for fan 304, as described above with respect to FIG. 3C.

Also as illustrated in FIG. 3E, user interface 332 displays expanded warning indicator 350 with more detailed information about the missing configuration of fan 304. For example, as illustrated in FIG. 3E, expanded warning indicator 350 includes a warning icon and text “Air filter needs replacement.” In some embodiments, expanded warning indicator 350 includes controls and/or support links for handling the missing configuration. In some embodiments, the type and/or content of expanded warning indicator 350 varies based on a type of error and/or type of accessory device. For example, expanded warning indicator 350 can include information relating to adding a PIN code if an accessory device is a door lock.

In some embodiments, computer system 300 determines specific intent at the granularity of content and/or controls, such as for warning indicator 350. In this example, specific intent is determined for displaying expanded warning indicator 350 based on the missing configuration of fan 304. In other embodiments, specific intent for displaying content is based on other factors, such as one or more factors described further below with respect to FIG. 3G and/or FIG. 3J.

As illustrated in FIG. 3F, fan 304 is operating in eco-mode, as indicated by indicator 306d including a leaf icon in user interface 306 of fan 304. In this example, computer system representation 300a is within larger proximity radius 308 relative to fan 304. In some embodiments, in response to computer system representation 300a being within larger proximity radius 308, computer system 300 detects a general intent for a user to interact with fan 304. And, in some embodiments, as illustrated in FIG. 3F, in response to detecting the general intent for a user to interact with fan 304, computer system 300 displays user interface 316. In some embodiments, user interface 316 includes a simplified set of controls for fan 304, as described above with respect to and/or as illustrated in FIG. 3B and FIG. 3D. Additionally, in this example, user interface 316 reflects the eco-mode that fan 304 is operating in by displaying mode indicator 320 with an eco-mode icon. It should be recognized that, in some embodiments, presence of the eco-mode icon can cause a determination to be made that a user has a specific intent to interact with fan 304 when computer system 300 has not previously displayed the eco-mode icon and/or the eco-mode icon has been displayed for less than a predefined period of time (e.g., 1 day to 1 week). In such embodiments, computer system 300 can display user interface 332 (e.g., as described below with respect to FIG. 3G) instead of user interface 316 (e.g., as described above with respect to FIG. 3F) even when computer system representation 300a is outside of smaller proximity radius 310 but inside larger proximity radius 308.

As illustrated in FIG. 3G, computer system representation 300a moves into smaller proximity radius 310, such as by a user holding computer system 300 while moving closer to fan 304. In some embodiments, in response to computer system representation 300a entering smaller proximity radius 310, computer system 300 detects a specific intent for a user to interact with fan 304. And, in some embodiments, as illustrated in FIG. 3G, computer system 300 changes display to user interface 332 in response to detecting the specific intent for a user to interact with fan 304. In some embodiments, user interface 332 includes a larger set of controls for fan 304, as described above with respect to FIG. 3C and FIG. 3E.

Also as illustrated in FIG. 3G, user interface 332 expands mode indicator 320 into mode controls menu 352. In some embodiments, mode controls menu 352 is specific intent content that is displayed based on a determination that a user of computer system 300 has not previously interacted with mode controls menu 352. In some embodiments, mode controls menu 352 is specific intent content that is displayed based on a determination that a user of computer system 300 has not interacted with mode controls menu 352 within a predefined period of time.

In some embodiments, mode controls menu 352 displays currently selected mode (e.g., eco-mode) and provides selectable mode options for switching between different modes for operating fan 304. For example, mode controls menu 352 includes mode options such as eco-mode 352a with an indicator “On” reflecting selection of this mode, night mode 352b, and full power mode 352b. It should be recognized that selectable mode options displayed in mode controls menu 352 can vary based on a type of an accessory device. For example, mode controls menu 352 can include options for different lighting scenes and/or color temperatures if an accessory device is a light.

As illustrated in FIG. 3H, computer system 300 is outside of larger proximity radius 308. In some embodiments, computer system 300 displays camera user interface 354 of a camera application, such as the camera application described above with respect to camera icon 312b. At FIG. 3H, a camera of computer system 300 is directed at fan 304. In response, in some embodiments, computer system 300 identifies fan 304 using one or more image and/or video analysis techniques, such as a machine learning algorithm for object detection and/or identification (such as You Only Look Once (YOLO), Faster R-CNN, and/or Single Shot Detectors (SSD)). In some embodiments, in response to identifying fan 304, computer system 300 displays button 356 that corresponds to fan 304 on camera user interface 354. In some embodiments, button 356 provides quick access to one or more user interfaces to interact with fan 304, such as user interface 316 and/or user interface 332, without requiring physical proximity to fan 306.

At FIG. 3H, computer system 300 detects input 305h on button 356. It should be recognized that input 305h is an example of a selection input and can be other types of inputs such as a verbal input, and/or an air gesture directed at button 356.

As illustrated in FIG. 3I, in response to detecting input 305h, computer system 300 displays user interface 316 by detecting general intent for a user to interact with fan 304. In some embodiments, user interface 316 includes a simplified set of controls for fan 304, as described above with respect to FIGS. 3B, 3D, and 3F. It should be noted that in this example, general intent is not detected via proximity of computer system 300 to fan 304, but by navigating via button 356 after detection of fan 304 via the camera of computer system 300. In some embodiments, specific intent is detected by navigating via button 356 after camera detection of fan 304 and, in response, computer system 300 displays user interface 332 instead of user interface 316. In other embodiments, specific intent can be detected by navigating via button 356 after camera detection of fan 304 if computer system 300 is within larger proximity radius 308 and/or smaller proximity radius 310.

At FIG. 3I, computer system 300 detects selection input 305i on more button 330. It should be recognized that selection input 305i is an example of a tap input and can be other types of inputs such as a verbal input, and/or an air gesture directed at more button 330.

As illustrated in FIG. 3J, in response to detecting selection input 305i, computer system 300 displays user interface 332. In some embodiments, user interface 332 includes a larger set of controls for fan 304, as described above with respect to FIGS. 3C, 3E, and 3G. It should be noted that in this example, computer system 300 is still outside of larger proximity radius 308, and that user interface 332 is displayed in response to detecting input 305i on button 330 that indicates an intent, such as general intent detected with respect to FIG. 3I, for a user to interact with fan 304. It should be recognized that more button 330 can operate similar to as described above with respect to FIGS. 6I-6J when used with respect to FIGS. 6B, 6D, and/or 6F. In some embodiments, intent is determined based on other factors such as detection of Near Field Communication (NFC) signals indicating close proximity and/or physical contact between computer system 300 and fan 304. For example, when computer system 300 detects an NFC tag embedded in fan 304, computer system 300 can interpret specific intent based on a user's deliberate action for a user to interact with fan 304. In some embodiments, intent is determined based on the time of day and/or activity history with fan 304. For example, during morning and/or evening hours, or at times when historical activity indicates frequent interaction with fan 304, computer system 300 can display interface 332 or user interface 316 and/or granular intent driven content, such as displaying mode controls menu 352 for switching an operational mode of fan 304 that computer system 300 predicts to be relevant at that time of day. Conversely, for another example, based on a time of year, such as during summer months and/or periods of high heat, computer system 300 may not display mode controls menu 352 while displaying user interface 332, as computer system 300 would not anticipate a user's intent to switch to eco-mode and/or use other power-saving controls for reducing cooling power of fan 304.

FIG. 4 is a flow diagram illustrating a process (e.g., process 400) for displaying different content based on user intent in accordance with some embodiments. Some operations in process 400 are, optionally, combined, the orders of some operations are, optionally, changed, and some operations are, optionally, omitted.

As described below, process 400 provides an intuitive way for displaying different content based on user intent. Process 400 reduces the cognitive burden on a user, thereby creating a more efficient human-machine interface. For battery-operated computing devices, enabling a user to interact with such devices faster and more efficiently conserves power and increases the time between battery charges.

In some embodiments, process 400 is performed at a computer system (e.g., 300) (e.g., an electronic device, a resident device, a controller device, a user device, a personal device, a watch, a phone, a tablet, a fitness tracking device, a processor, a head-mounted display (HMD) device, a communal device, and/or a media device) that is in communication with (and/or includes) one or more display generation components (e.g., a display screen, a projector, a head mounted display, and/or a touch-sensitive display).

The computer system detects (402) an accessory device (e.g., 304) (e.g., a computer system configured to be controlled by one or more other computer systems, such as the computer system) in proximity to (e.g., within 308 and/or 310) the computer system, wherein the accessory device is separate from the computer system. In some embodiments, detecting the accessory device in proximity to the computer system includes identifying a user of the computer system in proximity to the accessory device using one or more cameras and/or one or more microphones of (e.g., associated with, in communication with, and/or included in) the computer system (e.g., as described with respect to and/or illustrated in FIG. 3H). In some embodiments, detecting the accessory device in proximity to the computer system includes receiving, from the accessory device, a short-range communication, such as Bluetooth communication, near-field communication (NFC), and/or WiFi communication (e.g., as described with respect to FIG. 3A). In some embodiments, the accessory device is a fan, an air conditioning unit, a heating unit, a display, a television, a light, a lock, a security system, a speaker, an appliance, and/or a thermostat.

In response to (404) detecting the accessory device in proximity to the computer system, in accordance with a determination that a first set of one or more criteria is satisfied (e.g., that the user intends to interact with the accessory device in a first manner, that the user has a general intent to interact with the accessory device, that the user has a first intent with respect to the accessory device, and/or that a future interaction with the accessory device will be in a first manner) (e.g., as described above with respect to FIGS. 3A-3J), the computer system displays (406), via the one or more display generation components, a first set of content (e.g., 316, 322, 324, 326, 326, 330, 320, and/or 348) (e.g., a user interface, a user interface element, a virtual button, an icon, a widget, a control, and/or a window) corresponding to the accessory device. In some embodiments, the first set of content includes one or more controls for controlling the accessory device. In some embodiments, the first set of content includes information corresponding to the accessory device.

In response to (404) detecting the accessory device in proximity to the computer system, in accordance with a determination that a second set of one or more criteria is satisfied (e.g., that the user intends to interact with the accessory device in a second manner different from the first manner, that the user has a specific intent to interact with the accessory device, that the user has a second intent, different from the first intent, with respect to the accessory device, and/or that a future interaction with the accessory device will be in a second manner different from the first manner) (e.g., as described above with respect to FIGS. 3A-3J), the computer system displays (408), via the one or more display generation components, a second set of content (e.g., 332, 336, 338, 340, 342, 344, 346, 350, 352, 352a, 352b, and/or 352c) (e.g., a user interface, a user interface element, a virtual button, an icon, a widget, a control, and/or a window) corresponding to the accessory device (e.g., with or without displaying the first set of content corresponding to the accessory device), wherein the second set of content is different from the first set of content. In some embodiments, the second set of content includes the one or more controls for controlling the accessory device. In some embodiments, the second set content includes one or more controls for controlling the accessory device. In some embodiments, the one or more controls of the second set of content is different from the one or more controls of the first set of content. In some embodiments, the second set of content includes information corresponding to the accessory device. In some embodiments, the information of the second set of content is different from the information of the first set of content. In some embodiments, in response to detecting the accessory device in proximity to the computer system and in accordance with the determination that the first set of one or more criteria is satisfied, the computer system forgoes display of the second set of content corresponding to the accessory device. In some embodiments, detecting the accessory device in proximity to the computer system includes detecting the accessory device within a first distance (e.g., 308) (e.g., corresponding to the first set of one or more criteria being satisfied), a second distance (e.g., 310) (e.g., corresponding to the second set of one or more criteria being satisfied) different from the first distance, or a third distance (e.g., corresponding to the first set of one or more criteria and/or the second set of one or more criteria) of the computer system (e.g., as described with respect to and/or illustrated in FIGS. 3A-3J). In some embodiments, the second distance is less than the first distance.

In some embodiments, the first set of content includes a first set of one or more controls (e.g., 322, 324, 326, 326, and/or 330). In some embodiments, the second set of content includes a second set of one or more controls (e.g., 336, 338, 340, 342, 344, 346, 350, 352, 352a, 352b, and/or 352c) different from the first set of one or more controls. In some embodiments, the computer system is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the first set of content includes at least one control of the second set of one or more controls. In some embodiments, the second set of content includes at least one control of the first set of one or more controls. In some embodiments, while displaying the first set of one or more controls, the computer system detects, via the one or more input devices, an input (e.g., 305h or 305i) (e.g., a selection input, a tap input, and/or a voice request) corresponding to a control of the first set of one or more controls. In some embodiments, in response to detecting the input corresponding to the control of the first set of one or more controls, the computer system performs a first operation (e.g., as described with respect to FIGS. 3I-3J) (e.g., displays information, a user interface, and/or a user interface element, changes a state of the accessory device in accordance with the input, and/or initiates an application corresponding to the accessory device). In some embodiments, while displaying the second set of one or more controls, the computer system detects, via the one or more input devices, an input (e.g., 305i) (e.g., a selection input, a tap input, and/or a voice request) corresponding to a control of the second set of one or more controls. In some embodiments, in response to detecting the input corresponding to the control of the second set of one or more controls, the computer system performs a second operation (e.g., as described with respect to FIG. 3J) (e.g., displays information, a user interface, and/or a user interface element, changes a state of the accessory device in accordance with the input, and/or initiates an application corresponding to the accessory device) different from the first operation.

In some embodiments, the first set of content includes a first set of information (e.g., 320 and/or 348) (e.g., received and/or obtained from the accessory device). In some embodiments, the second set of content includes a second set of information (e.g., 350) (e.g., received and/or obtained from the accessory device) different from the first set of information. In some embodiments, the first set of information includes at least some information of the second set of information. In some embodiments, the second set of information includes at least some information of the first set of information.

In some embodiments, the second set of content includes a list of operations performed by the accessory device (e.g., as described with respect to FIG. 3C) (e.g., in a predefined period of time, such as in the last day, week, or month, and/or since a list of operations performed by the accessory device has been previously displayed). In some embodiments, the list of operations performed by the accessory device includes an indication of a first operation and an indication of a second operation different from the first operation. In some embodiments, the indication of the second operation is different from the indication of the first operation. In some embodiments, the indication of the first operation includes an identification of (1) the first operation and/or (2) a result of the first operation. In some embodiments, the indication of the second operation includes an identification of (1) the second operation and/or (2) a result of the second operation.

In some embodiments, the first set of one or more criteria includes a criterion that is satisfied when the computer system is within a first distance (e.g., 308) of the computer system. In some embodiments, the second set of one or more criteria includes a criterion that is satisfied when the computer system is within a second distance (e.g., 310) of the computer system. In some embodiments, the second distance is different from (e.g., more or less than) the first distance. In some embodiments, the criterion that is satisfied when the computer system is within the first distance of the computer system is not satisfied when the computer system is within the second distance of the computer system.

In some embodiments, the first set of one or more criteria includes a criterion that is satisfied when the accessory device is not missing a configuration (e.g., a setting and/or an attribute of the accessory device). In some embodiments, the second set of one or more criteria includes a criterion that is satisfied when the accessory device is missing a configuration (e.g., as described with respect to and/or illustrated in FIGS. 3D-3E) (e.g., a setting and/or an attribute of the accessory device has not been defined and/or set by a controller device, such as the computer system).

In some embodiments, the first set of one or more criteria includes a criterion that is satisfied when a current time (e.g., a current time of day, such as hour, minute, and/or second) is a first time. In some embodiments, the second set of one or more criteria includes a criterion that is satisfied when the current time is a second time different from the first time (e.g., as described with respect to FIG. 3J).

In some embodiments, the first set of one or more criteria includes a criterion that is satisfied when a current part of a year (e.g., a current time of year, a current day, a current week, a current month, and/or a current season) is a first part of the year. In some embodiments, the second set of one or more criteria includes a criterion that is satisfied when the current part of the year is a second part of the year different from the first part of the year (e.g., as described with respect to FIG. 3J).

In some embodiments, the first set of one or more criteria does not include a criterion that is satisfied when a message is exchanged via near-field communication (NFC) between the computer system and the accessory device (e.g., sent by the computer system to the accessory device and/or received by the computer system from the accessory device). In some embodiments, the second set of one or more criteria includes a criterion that is satisfied when a message is exchanged via NFC between the computer system and the accessory device (e.g., as described with respect to FIG. 3H). In some embodiments, the first set of one or more criteria does not include a criterion that is satisfied when the computer system and the accessory device are in communication via a first short-range communication channel (e.g., Bluetooth, WiFi, Zigbee, Infrared, Ultra-Wideband, and/or NFC). In some embodiments, the computer system and the accessory device are in communication via another communication channel different from the first short-range communication channel. In some embodiments, the other communication channel is a short-range communication channel or a long-range communication channel. In some embodiments, the second set of one or more criteria includes a criterion that is satisfied when the computer system and the accessory device are in communication via a first short-range communication channel (e.g., Bluetooth, WiFi, Zigbee, Infrared, Ultra-Wideband, and/or NFC).

In some embodiments, the first set of one or more criteria includes a criterion that is satisfied when the computer system (e.g., 300) has a first orientation (e.g., detected using UWB, LiDAR, a camera, and/or a microphone) relative to the accessory device (e.g., 304). In some embodiments, the second set of one or more criteria includes a criterion that is satisfied when the computer system has a second orientation (e.g., detected using UWB, LiDAR, a camera, and/or a microphone) relative to the accessory device (and/or when the computer system does not have the first orientation relative to the accessory device). In some embodiments, the second orientation is different from the first orientation.

In some embodiments, the accessory device is a first accessory device. In some embodiments, the first set of one or more criteria is a determination that a user of the computer system has a first level of intent to interact (e.g., a general and/or low level of intent to interact) with the first accessory device. In some embodiments, the second set of one or more criteria is a determination that a user of the computer system has a second level of intent to interact (e.g., a specific and/or high level of intent to interact) with the first accessory device. In some embodiments, the second level of intent is different from the first level of intent (e.g., level of intent as described with respect to FIGS. 3A-3J). In some embodiments, the computer system detects a second accessory device (e.g., a computer system configured to be controlled by one or more other computer systems, such as the computer system) in proximity to the computer system (e.g., 300), wherein the second accessory device is separate from the computer system and the first accessory device. In some embodiments, detecting the second accessory device in proximity to the computer system includes identifying a user of the computer system in proximity to the second accessory device using one or more cameras and/or one or more microphones of (e.g., associated with, in communication with, and/or included in) the computer system. In some embodiments, detecting the second accessory device in proximity to the computer system includes receiving, from the second accessory device, a short-range communication, such as Bluetooth communication, near-field communication (NFC), and/or WiFi communication. In some embodiments, the second accessory device is a fan, an air conditioning unit, a heating unit, a display, a television, a light, a lock, a security system, a speaker, an appliance, and/or a thermostat. In some embodiments, in response to detecting the second accessory device in proximity to the computer system, in accordance with a determination that a third set of one or more criteria is satisfied, wherein the third set of one or more criteria is different from the first set of one or more criteria (and/or the second set of one or more criteria), wherein the third set of one or more criteria is a determination that a user of the computer system has the first level of intent (e.g., level of intent as described with respect to FIGS. 3A-3J) to interact (e.g., a general and/or low level of intent to interact) with the second accessory device (e.g., that the user intends to interact with the second accessory device in the first manner, that the user has a general intent to interact with the second accessory device, that the user has a first intent with respect to the second accessory device, and/or that a future interaction with the second accessory device will be in the first manner), the computer system displays, via the one or more display generation components, a first set of content (e.g., a user interface, a user interface element, a virtual button, an icon, a widget, a control, and/or a window) corresponding to the second accessory device. In some embodiments, the first set of content corresponding to the second accessory device includes one or more controls for controlling the second accessory device. In some embodiments, the first set of content corresponding to the second accessory device includes information corresponding to the second accessory device. In some embodiments, in response to detecting the second accessory device in proximity to the computer system, in accordance with a determination that a fourth set of one or more criteria is satisfied, wherein the fourth set of one or more criteria is different from the second set of one or more criteria and the third set of one or more criteria (and/or the first set of one or more criteria), wherein the fourth set of one or more criteria is a determination that a user of the computer system has the second level of intent (e.g., level of intent as described with respect to FIGS. 3A-3J) to interact (e.g., a general and/or low level of intent to interact) with the second accessory device (e.g., that the user intends to interact with the second accessory device in the second manner, that the user has a specific intent to interact with the second accessory device, that the user has the second intent with respect to the second accessory device, and/or that a future interaction with the second accessory device will be in the second manner), the computer system displays, via the one or more display generation components, a second set of content (e.g., a user interface, a user interface element, a virtual button, an icon, a widget, a control, and/or a window) corresponding to the second accessory device (e.g., with or without displaying the first set of content corresponding to the second accessory device), wherein the second set of content corresponding to the second accessory device is different from the first set of content corresponding to the second accessory device. In some embodiments, the second set of content corresponding to the second accessory device includes the one or more controls for controlling the second accessory device. In some embodiments, the second set content corresponding to the second accessory device includes one or more controls for controlling the second accessory device. In some embodiments, the one or more controls of the second set of content corresponding to the second accessory device is different from the one or more controls of the first set of content corresponding to the second accessory device. In some embodiments, the second set of content corresponding to the second accessory device includes information corresponding to the second accessory device. In some embodiments, the information of the second set of content corresponding to the second accessory device is different from the information of the first set of content corresponding to the second accessory device. In some embodiments, in response to detecting the second accessory device in proximity to the computer system and in accordance with the determination that the third set of one or more criteria is satisfied, the computer system forgoes display of the second set of content corresponding to the second accessory device. In some embodiments, detecting the second accessory device in proximity to the computer system includes detecting the second accessory device within a fourth distance (e.g., corresponding to the third set of one or more criteria being satisfied), a fifth distance (e.g., corresponding to the fourth set of one or more criteria being satisfied) different from the fourth distance, or a sixth distance (e.g., corresponding to the first set of one or more criteria and/or the second set of one or more criteria) of the computer system. In some embodiments, the fifth distance is less than the fourth distance.

In some embodiments, the first set of one or more criteria includes a criterion that is satisfied when the accessory device has a first state (e.g., a value of a setting, such as fan speed, humidity level, brightness level, night mode, and/or eco-mode). In some embodiments, the second set of one or more criteria includes a criterion that is satisfied when the accessory device has a second state different from the first state (e.g., state as described with respect to and/or illustrated in FIGS. 3C-3D).

In some embodiments, the second state is an error state (e.g., a state in which the accessory device needs an operation to be performed). In some embodiments, the first state is a non-error state (e.g., state as described with respect to and/or illustrated in FIGS. 3C-3D) (e.g., a state in which the accessory device is operating without issue and/or does not need an operation to be performed).

In some embodiments, the second set of one or more criteria includes a criterion that is satisfied when the accessory device has changed to the second state within a predefined period of time (e.g., state as described with respect to and/or illustrated in FIGS. 3C-3D) (e.g., 1 second to 1 day). In some embodiments, the first set of one or more criteria includes a criterion that is satisfied when the accessory device has changed to the first state at a time longer than the predefined period of time. In some embodiments, a difference between the first set of one or more criteria is not based on when the accessory device has changed to a state but rather what state is a current state.

In some embodiments, the second set of one or more criteria includes a criterion that is satisfied when an indication of the second state has not been displayed by the computer system since the accessory device changed to the second state (e.g., state as described with respect to FIG. 3G). In some embodiments, the first set of one or more criteria includes a criterion that is satisfied when an indication of the first state has been displayed by the computer system since the accessory device changed to the first state. In some embodiments, a difference between the first set of one or more criteria is not based on what has been displayed by the computer system but rather what state is a current state. In some embodiments, the indication of the second state is an identification of the second state.

In some embodiments, the second set of one or more criteria includes a criterion that is satisfied when the accessory device is currently outputting (e.g., visually and/or auditorily outputting, such as via the one or more display generation components and/or one or more speakers) first content (e.g., content as described with respect to and/or illustrated in FIGS. 3B-3G and/or FIGS. 3I-3J) (e.g., information, a user interface element, and/or content corresponding to the accessory device, such as an indication and/or an identification of a current state of the accessory device).

In some embodiments, the first content does not include the second set of content. In some embodiments, the first content includes the first set of content. In some embodiments, the first content does not include the first set of content.

In some embodiments, while displaying the first set of content in accordance with the determination that the first set of one or more criteria is satisfied, the computer system detects a change (e.g., change as described with respect to and/or illustrated in FIGS. 3C-3G and/or FIGS. 3I-3J) (e.g., with respect to the computer system and/or the accessory device, such as a change that causes the first set of one or more criteria to no longer be satisfied and the second set of one or more criteria to be satisfied). In some embodiments, the change is a change in distance between the computer system and the accessory device. In some embodiments, the change is a change in a state of the accessory device. In some embodiments, the change is a change in what is output by the accessory device. In some embodiments, the change is a change in time of day. In some embodiments, the change is when a message is exchanged via NFC between the computer system the accessory device. In some embodiments, the change is a change in orientation of the computer system relative to the accessory device. In some embodiments, in response to detecting the change and in accordance with a determination that the second set of one or more criteria is satisfied, the computer system displays, via the one or more display generation components, the second set of content corresponding to the accessory device (e.g., as described with respect to and/or illustrated in FIGS. 3C-3G and/or FIGS. 3I-3J) (e.g., with or without displaying the first set of content corresponding to the accessory device).

In some embodiments, while displaying the first set of content, the computer system detects that the accessory device is no longer in proximity to the computer system. In some embodiments, in response to detecting that the accessory device is no longer in proximity to the computer system, the computer system ceases display of the first set of content. In some embodiments, while displaying the second set of content, the computer system detects that the accessory device is no longer in proximity to the computer system. In some embodiments, in response to detecting the accessory device is no longer in proximity to the computer system while displaying the second set of content, the computer system ceases display of the second set of content.

In some embodiments, while displaying the second set of content, the computer system detects that the accessory device is no longer in proximity to the computer system. In some embodiments, in response to detecting that the accessory device is no longer in proximity to the computer system, the computer system maintains display of the second set of content (e.g., as described with respect to and/or illustrated in FIGS. 3I-3J). In some embodiments, while displaying the first set of content, the computer system detects that the accessory device is no longer in proximity to the computer system. In some embodiments, in response to detecting the accessory device is no longer in proximity to the computer system while displaying the first set of content, the computer system maintains display of the first set of content.

In some embodiments, the first set of content corresponds to a first application (e.g., an accessory management application, an application corresponding to and/or associated with the accessory device, and/or an operating system of the computer system). In some embodiments, while detecting the accessory device in proximity to the computer system, the computer system displays, via the one or more display generation components, a user interface of a second application (e.g., a note-taking application, a word-processing application, a document-processing application, a presentation application, an email application, a form processing application such as a PDF viewer and/or editor, a game, a messaging application, a maps application, a fitness application, a health application, a digital payments application, a media application, and/or a social network application) different from the first application, wherein the first set of content (and/or the second set of content) is displayed on top of (and/or with) the user interface (e.g., as described with respect to and/or illustrated in FIGS. 3B-3C). In some embodiments, in response to detecting the accessory device in proximity to the computer system and in accordance with the determination that the first set of one or more criteria is satisfied (and/or in accordance with the determination that the second set of one or more criteria is satisfied), the computer system ceases display of the user interface of the second application.

In some embodiments, while detecting the accessory device in proximity to the computer system, the computer system displays, via the one or more display generation components, a lockscreen (e.g., a graphical user interface that prevents access to one or more functions of the computer system until a specific action is performed), wherein the first set of content (and/or the second set of content) is displayed with (and/or on top of) the lockscreen (e.g., as described with respect to and/or illustrated in FIGS. 3A-3J). In some embodiments, in response to detecting the accessory device in proximity to the computer system and in accordance with the determination that the first set of one or more criteria is satisfied (and/or in accordance with the determination that the second set of one or more criteria is satisfied), the computer system ceases display of the lockscreen.

In some embodiments, process 400 (FIG. 4) is performed at a first computer system (as described herein) via a system process (e.g., an operating system process and/or a server system process) that is different from one or more applications executing and/or installed on the first computer system.

In some embodiments, process 400 (FIG. 4) is performed at a first computer system (as described herein) by an application that is different from a system process.

In some embodiments, the instructions of the application, when executed, control the first computer system to perform process 400 (FIG. 4) by calling an application programming interface (API) provided by the system process. In some embodiments, the application performs at least a portion of process 400 (FIG. 4) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform process 400 (FIG. 4) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform process 400 (FIG. 4) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to process 400 (FIG. 4).

In some embodiments, API 176 defines a first API call response that can be provided to an application by API calling instructions 174, wherein the first API call response includes parameters described above with respect to process 400 (FIG. 4).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve content for interacting with accessories based on user intent. The present disclosure contemplates that in some instances, this gathered data can include personal information data that uniquely identifies or can be used to adapt content for interacting with accessories. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change content displayed for interacting with accessories. Accordingly, use of such personal information data enables improves user interactions with these accessories. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be adapted to users for interacting with accessories by inferring user intent based on non-personal information data or a bare minimum amount of personal information, such as the content being requested by the device associated with a user or other non-personal information.

What is claimed is:

1. A method, comprising:
at a computer system that is in communication with one or more display generation components:
detecting an accessory device in proximity to the computer system, wherein the accessory device is separate from the computer system; and
in response to detecting the accessory device in proximity to the computer system:
in accordance with a determination that a first set of one or more criteria is satisfied, displaying, via the one or more display generation components, a first set of content corresponding to the accessory device; and
in accordance with a determination that a second set of one or more criteria is satisfied, displaying, via the one or more display generation components, a second set of content corresponding to the accessory device, wherein the second set of content is different from the first set of content.

2. The method of claim 1, wherein the first set of content includes a first set of one or more controls, wherein the second set of content includes a second set of one or more controls different from the first set of one or more controls, wherein the computer system is in communication with one or more input devices, the method further comprising:
While displaying the first set of one or more controls, detecting, via the one or more input devices, an input corresponding to a control of the first set of one or more controls;
in response to detecting the input corresponding to the control of the first set of one or more controls, performing a first operation;
while displaying the second set of one or more controls, detecting, via the one or more input devices, an input corresponding to a control of the second set of one or more controls; and
in response to detecting the input corresponding to the control of the second set of one or more controls, performing a second operation different from the first operation.

3. The method of claim 1, wherein the first set of content includes a first set of information, wherein the second set of content includes a second set of information different from the first set of information.

4. The method of claim 1, wherein the second set of content includes a list of operations performed by the accessory device.

5. The method of claim 1, wherein the first set of one or more criteria includes a criterion that is satisfied when the computer system is within a first distance of the computer system, wherein the second set of one or more criteria includes a criterion that is satisfied when the computer system is within a second distance of the computer system, and wherein the second distance is different from the first distance.

6. The method of claim 1, wherein the first set of one or more criteria includes a criterion that is satisfied when the accessory device is not missing a configuration, and wherein the second set of one or more criteria includes a criterion that is satisfied when the accessory device is missing a configuration.

7. The method of claim 1, wherein the first set of one or more criteria includes a criterion that is satisfied when a current time is a first time, and wherein the second set of one or more criteria includes a criterion that is satisfied when the current time is a second time different from the first time.

8. The method of claim 1, wherein the first set of one or more criteria includes a criterion that is satisfied when a current part of a year is a first part of the year, and wherein the second set of one or more criteria includes a criterion that is satisfied when the current part of the year is a second part of the year different from the first part of the year.

9. The method of claim 1, wherein the first set of one or more criteria does not include a criterion that is satisfied when a message is exchanged via near-field communication (NFC) between the computer system and the accessory device, and wherein the second set of one or more criteria includes a criterion that is satisfied when a message is exchanged via NFC between the computer system and the accessory device.

10. The method of claim 1, wherein the first set of one or more criteria includes a criterion that is satisfied when the computer system has a first orientation relative to the accessory device, wherein the second set of one or more criteria includes a criterion that is satisfied when the computer system has a second orientation relative to the accessory device, wherein the second orientation is different from the first orientation.

11. The method of claim 1, wherein the accessory device is a first accessory device, wherein the first set of one or more criteria is a determination that a user of the computer system has a first level of intent to interact with the first accessory device, wherein the second set of one or more criteria is a determination that a user of the computer system has a second level of intent to interact with the first accessory device, wherein the second level of intent is different from the first level of intent, the method further comprising:
detecting a second accessory device in proximity to the computer system, wherein the second accessory device is separate from the computer system and the first accessory device; and
in response to detecting the second accessory device in proximity to the computer system:
in accordance with a determination that a third set of one or more criteria is satisfied, wherein the third set of one or more criteria is different from the first set of one or more criteria, wherein the third set of one or more criteria is a determination that a user of the computer system has the first level of intent to interact with the second accessory device, displaying, via the one or more display generation components, a first set of content corresponding to the second accessory device; and
in accordance with a determination that a fourth set of one or more criteria is satisfied, wherein the fourth set of one or more criteria is different from the second set of one or more criteria and the third set of one or more criteria, wherein the fourth set of one or more criteria is a determination that a user of the computer system has the second level of intent to interact with the second accessory device, displaying, via the one or more display generation components, a second set of content corresponding to the second accessory device, wherein the second set of content corresponding to the second accessory device is different from the first set of content corresponding to the second accessory device.

12. The method of claim 1, wherein the first set of one or more criteria includes a criterion that is satisfied when the accessory device has a first state, and wherein the second set of one or more criteria includes a criterion that is satisfied when the accessory device has a second state different from the first state.

13. The method of claim 12, wherein the second state is an error state, and wherein the first state is a non-error state.

14. The method of claim 12, wherein the second set of one or more criteria includes a criterion that is satisfied when the accessory device has changed to the second state within a predefined period of time.

15. The method of claim 12, wherein the second set of one or more criteria includes a criterion that is satisfied when an indication of the second state has not been displayed by the computer system since the accessory device changed to the second state.

16. The method of claim 1, wherein the second set of one or more criteria includes a criterion that is satisfied when the accessory device is currently outputting first content.

17. The method of claim 16, wherein the first content does not include the second set of content.

18. The method of claim 1, further comprising:
while displaying the first set of content in accordance with the determination that the first set of one or more criteria is satisfied, detecting a change; and
in response to detecting the change and in accordance with a determination that the second set of one or more criteria is satisfied, displaying, via the one or more display generation components, the second set of content corresponding to the accessory device.

19. The method of claim 1, further comprising:
while displaying the first set of content, detecting that the accessory device is no longer in proximity to the computer system; and
in response to detecting that the accessory device is no longer in proximity to the computer system, ceasing display of the first set of content.

20. The method of claim 1, further comprising:
while displaying the second set of content, detecting that the accessory device is no longer in proximity to the computer system; and
in response to detecting that the accessory device is no longer in proximity to the computer system, maintaining display of the second set of content.

21. The method of claim 1, wherein the first set of content corresponds to a first application, the method further comprising:
while detecting the accessory device in proximity to the computer system, displaying, via the one or more display generation components, a user interface of a second application different from the first application, wherein the first set of content is displayed on top of the user interface.

22. The method of claim 1, further comprising:
while detecting the accessory device in proximity to the computer system, displaying, via the one or more display generation components, a lockscreen, wherein the first set of content is displayed with the lockscreen.

23. A non-transitory computer-readable storage medium storing one or more programs configured to be executed by one or more processors of a computer system that is in communication with one or more display generation components, the one or more programs including instructions for:
detecting an accessory device in proximity to the computer system, wherein the accessory device is separate from the computer system; and
in response to detecting the accessory device in proximity to the computer system:
in accordance with a determination that a first set of one or more criteria is satisfied, displaying, via the one or more display generation components, a first set of content corresponding to the accessory device; and
in accordance with a determination that a second set of one or more criteria is satisfied, displaying, via the one or more display generation components, a second set of content corresponding to the accessory device, wherein the second set of content is different from the first set of content.

24. A computer system configured to communicate with one or more display generation components, the computer system comprising:
one or more processors; and
memory storing one or more programs configured to be executed by the one or more processors, the one or more programs including instructions for:
detecting an accessory device in proximity to the computer system, wherein the accessory device is separate from the computer system; and
in response to detecting the accessory device in proximity to the computer system:
in accordance with a determination that a first set of one or more criteria is satisfied, displaying, via the one or more display generation components, a first set of content corresponding to the accessory device; and
in accordance with a determination that a second set of one or more criteria is satisfied, displaying, via the one or more display generation components, a second set of content corresponding to the accessory device, wherein the second set of content is different from the first set of content.
